(19) United States
(12) Patent Application Publication
(10) Pub. No.: US 2004/0034858 A1
(43) Pub. Date: Feb. 19, 2004

(54) Programming a multi-threaded processor

(76) Inventor: Robert J. Kushlis, Worcester, MA (US)

Correspondence Address: SCOTT C. HARRIS, Fish & Richardson P.C., 4350 La Jolla Village Drive, Suite 500, San Diego, CA, 92122, US

(21) Appl. No.: 10/219,588

(22) Filed: Aug. 14, 2002

(51) Int. Cl. G06F 9/00

(52) U.S. Cl. 718/108

(57) ABSTRACT

A computer instruction includes a declaration instruction that results in a variable name being associated with a memory location in one of a plurality of memories, the declaration instruction having a first field to specify the variable name, a second field to specify a one of the plurality of memory systems to associate with the variable name.

### TECHNICAL FIELD

This application relates to compilation techniques and instructions for programming.

### BACKGROUND

Parallel processing is an efficient form of information processing of concurrent events in a computing process. In the context of a parallel processor, parallelism involves doing more than one thing at the same time. Unlike a serial paradigm where all tasks are performed sequentially at a single station or a pipelined machine where tasks are performed at specialized stations, with parallel processing, many stations are provided, each capable of performing various tasks simultaneously. A number of stations work simultaneously and independently on the same or common elements of a computing task. Accordingly, using or applying parallel processing can solve computing tasks.

A compiler program is generally used to convert a source code file written in a high-level programming language (e.g., COBOL, C, C++, etc.) into an executable program, i.e., a corresponding set of machine language instructions that are executable by a computer processor. The compiler typically performs a multi-step process that begins with converting each high-level source code file into a corresponding assembly language file followed by converting each assembly language files into a corresponding machine language file. A link editor (a “linker”) is then used to combine each of the machine language files into a single executable program. The format of the machine language instructions included in the executable program are specific to the architecture of the computer processor that will be used to execute the program.

### DESCRIPTION OF THE DRAWINGS

FIG. 1 is a block diagram of a processing system having multiple memories.

FIG. 2 is a flowchart showing a compilation process.

FIG. 3 is a more detailed block diagram of a portion of the processing system of FIG. 1.

FIG. 4 is a block diagram of computer hardware for execution of the compilation process of FIG. 2.

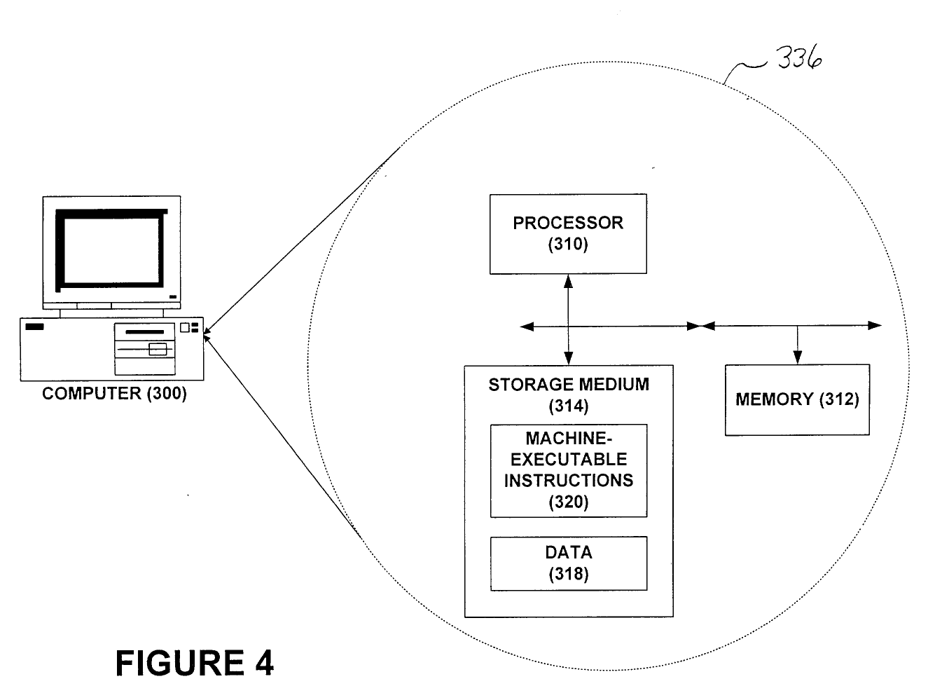

### DESCRIPTION

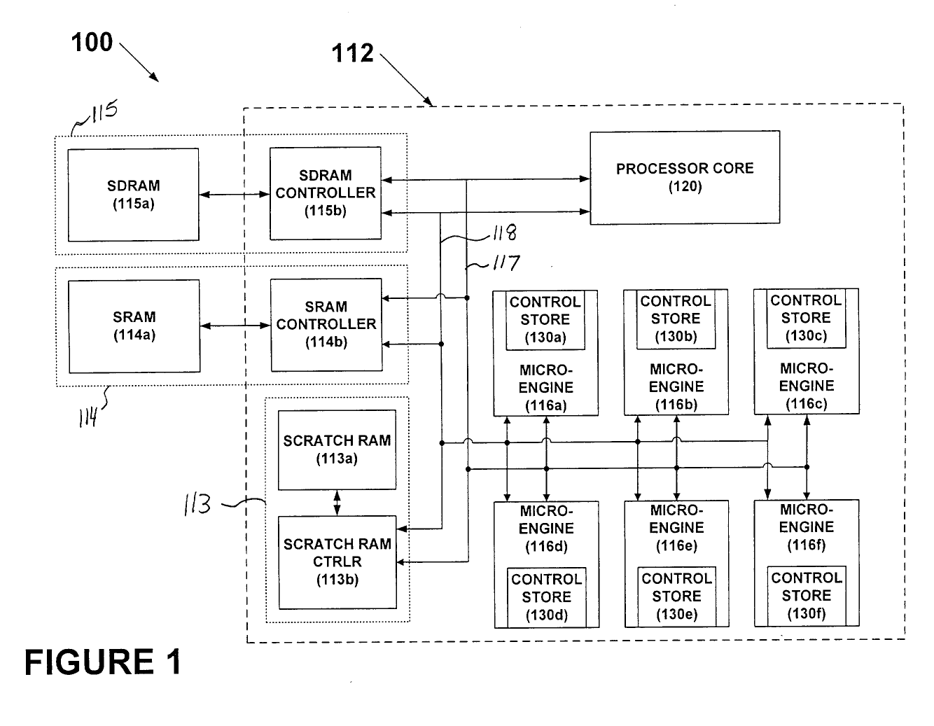

Referring to FIG. 1, processing system 100 includes a parallel, hardware-based multithreaded processor module 112 that includes a processor core 120. Processor core 120 performs general purpose computer type functions such as handling protocols, exceptions, and providing extra support for packet processing where the programmable micro-engines 116a-116f process the packets and, in some cases, pass the packets off to processor core 120 (e.g.) for more detailed processing such as in boundary conditions.

A programmable micro-engines 116a-116f includes a control store 130a-130f, respectively, which in this example are implemented as random access memories (RAMs) of 4096 instructions, each of which is 40-bits wide. Control stores 130a-130f are used to store an executable program, or a portion of an executable program, compiled by process 200. The executable programs are loadable into control stores 130a-130f by processor core 120.

The programming engines 116a-116f each maintain program counters in hardware and states associated with the program counters. Effectively, corresponding sets of context or threads can be simultaneously active on each of the programming engines 116a-116f while only one is actually executing at any one time.

Memory sub-system 113 includes a SCRATCH random access memory 113a (SCRATCH RAM 113) and a memory controller 113b, both of which are included on processor module 112. Memory sub-system 114 includes a static random access memory 114a (SRAM 114a), and a corresponding SRAM controller 114b. Memory sub-system 115 includes a synchronous dynamic random access memory 115a (SDRAM 115a) and a corresponding SDRAM controller 115b. In this example, SRAM controller 114b and SDRAM controller 115b are both located on processor module 112, while their corresponding memories SRAM 114a and SDRAM 115a are not. All of the memory controllers 113b-115b are connected by command/address bus 117 and data bus 118 to micro-engines 116a-116f and a core processor 120. The memory sub-systems operate asynchronously, receiving memory access requests (e.g., reads, writes and swaps) from the micro-engines and the core processor.

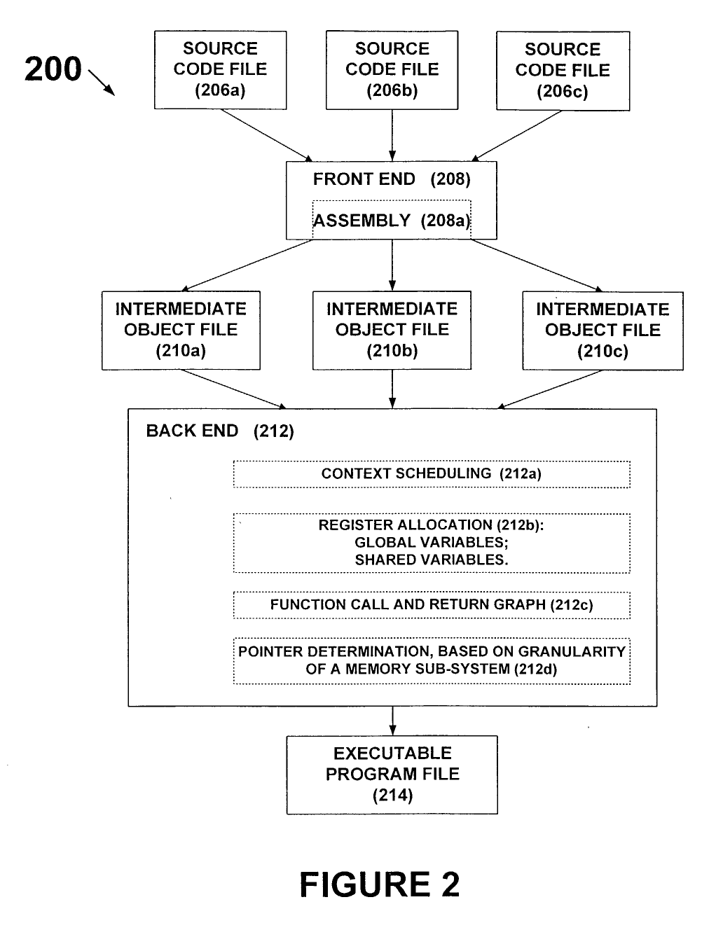

SDRAM memory 115a and SDRAM controller 115b are typically used for storing and processing large volumes of data, respectively. For example, storing and processing of network payloads from network packets. SRAM memory 114a and SRAM controller 114b are typically used in a networking implementation for low latency, fast access tasks, e.g., accessing look-up tables, memory for the core processor 120, and the like. Referring to FIG. 2, a compilation process 200 is used to compile an executable program 214 from source code files 206a-206c that include extended high-level language (XHLL) instructions. Executable program 214 may be executed by programmable micro-engines 116a-116f included in the parallel processing system 100 (FIG. 1). In this example of processing system 100, the command/address bus 117 and data bus 118 connect micro-engines 116a-116f and three memory sub-systems 113-115. Each of the memory sub-systems 113-115 operates asynchronously and has different access speeds and may also have different read and write data sizes.

Each of the programmable micro-engines 116a-116f supports parallel execution of multiple contexts or threads. Multi-threaded execution allows a thread to perform computations while another thread waits for an input-output (I/O) operation to complete, typically, a memory access to one of the memory sub-systems, or for a signal from another hardware unit to be received. If only single-threaded execution was supported, the programmable micro-engines would sit idle for a significant number of cycles waiting for memory references to complete or signals to be received reducing overall computational throughput of system 100. In an embodiment, XHLL instructions are implemented in a “C” language format (a syntax) and include a set of memory specifiers and context synchronization specifiers. The set of memory specifiers includes specifiers corresponding to each of the memory sub-systems 113-115, and are used to specify an access type operation (i.e., a read or write) to be performed by a specific memory sub-system. The set of context synchronization specifiers are used to indicate under what conditions an executing thread may be swapped in or out of execution by micro-engine, as will be explained. The use of XHLL instructions that include memory and context synchronization specifiers, may provide a programmer the ability to control specific hardware and/or context scheduling features of processing system 100. Furthermore, the use of XHLL instructions to program processing system 100 may enable a programmer to efficiently schedule multi-threaded execution by a micro-engine, e.g., where an executing thread may need to wait for a requested memory access to complete. The use of XHLL instructions to program processing system 100 also may reduce program development time since the need for specialized knowledge of the processor architecture is not required. That is, a programmer may be able to program the operation of specific hardware included in processing system 100 using high-level language instructions rather than using relatively more difficult assembly-level language instructions.

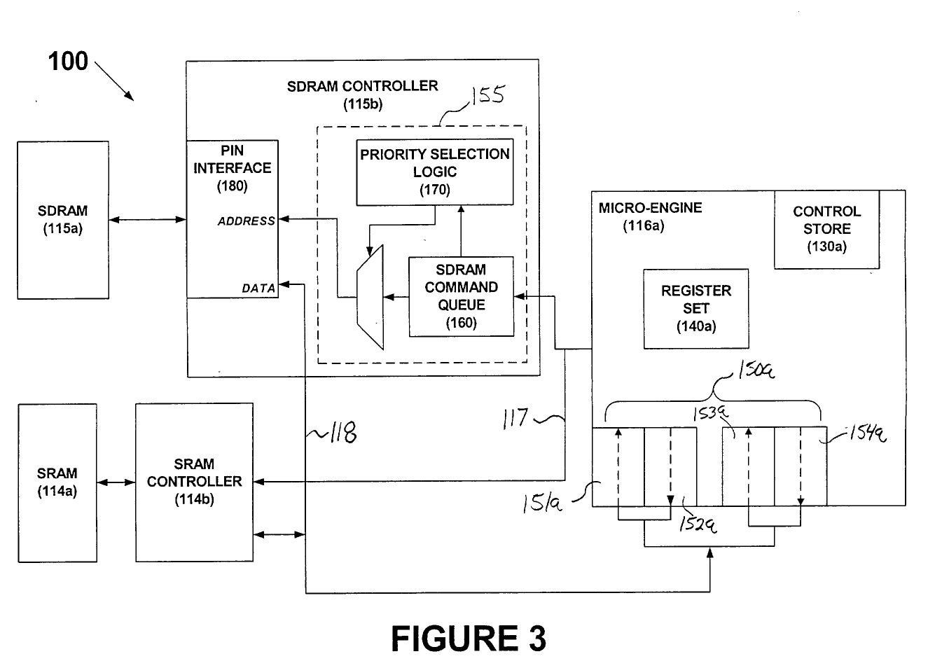

Referring to FIG. 3, an exemplary micro-engine 116a and an exemplary memory controller, e.g., SDRAM controller 115b are shown in greater detail. The other micro-engines (116b-116f) are constructed similarly. The other memory controllers (113b-114b) may be constructed in a similar fashion. Micro-engine 116a includes a set of 128 transfer registers 150a (hereafter referred to as “XFR's”), divided logically into four sets of 32×FRs 151a-154a. Each of the four sets of XFRs are used for reading or writing data to a specific memory sub-system. In more detail, XFR set 151a is used for data reads from SDRAM 115a, XFR set 152a is used for data writes to SDRAM 115a, XFR set 153a is used for data reads from SRAM 114a and XFR set 154a is used for data writes to SRAM 114a.

Exemplary memory controller 115b includes queuing logic 155 that is used to store and select among memory access commands received from the micro-engines 116a-116f and/or core processor 120. Each of the memory access commands sent to a memory controller includes an address field to specify an address location in a memory, a command field to specify the type of access (i.e, a read or write) and may also include an access size (e.g., a byte, word, long-word, etc.) In this example, queueing logic 155 includes a command queue 160 to store memory access commands received on command/address bus 117, and a selection logic block 170 connected to control an output from MUX 162 to select a stored memory access instructions from command queue 160. The output from MUX 162 includes the address field from the selected memory access instruction, which is input to a pin interface block 180 along with the corresponding data on bus 118. In an embodiment, the set of XHLL instructions includes a queueing priority specifier that when compiled and executed by a micro-engine causes a memory access instruction to be sent to a memory controller that includes a field corresponding to the queueing priority specifier. In this example, the queuing priority specifier field included in a memory access instruction sent to memory controller 115b, is used by selection logic block 170 to determine the selection of a stored memory access command from command queue 160.

Processing system 100 is especially useful for tasks that can be broken into parallel subtasks or functions. In this example, each of the six programmable micro-engines 116a-116f may execute up to four (4) threads. Executable programs compiled by process 200 are executed in each of programmable micro-engines 116a-116f and may cause memory accesses to DRAM 115a, SRAM 114a or SCRATCH RAM 113a. Programs written with XHLL instructions allow a programmer to select which of the memory sub-systems 113-115 to access based on characteristics of the data. Typically, low latency, low bandwidth data is stored in and fetched from SRAM memory 114a or SCRATCH RAM 113a, whereas higher bandwidth data for which latency is not as important, is stored in and fetched from SDRAM memory 115a.

Exemplary micro-engine 116c includes a register set 140 that includes a program counter (PC), and context specific local registers to allow for context swapping of the multiple contexts on each micro-engine. The other micro-engines, 116b-116f are constructed similarly. These registers sets are used to store context specific information and eliminates the need to move some of that information between a memory sub-system and the register set for each context swap performed by a micro-engine.

In this example of processing system 100, processor core 120 is an XScale™ based architecture. The processor core 120 has an operating system (not shown). Through the operating system (OS), the processor core 120 can call functions to operate on the programmable micro-engines 116a-116f. The processor core 120 can use any supported OS, in particular, a real time OS. For the core processor 20 implemented as an XScale™ architecture, operating systems such as Microsoft NT real-time, VXWorks and μCOS, or a freeware OS available over the Internet can be used.

Each of the memory sub-systems 113-115 has a separate address space. Also, in this example of processing system 100, SCRATCH RAM 113a and SRAM 114a are addressable by longwords (32 bits) and SDRAM 115a is addressable by quadwords (64 bits). As stated previously, accesses to memory sub-systems 113-115 are completed asynchronously. Therefore, when a memory location in one of the memory sub-systems is accessed by a program executing in a micro-engine, the thread must either be swapped out (by executing a context swap instruction), allowing other threads to run, or must wait until the operation is signaled as complete before using the data being read. Similarly, when a data value is being written to a memory sub-system by a first instruction, that data value may not be read by a second instruction before the write to that memory has completed.

The use of XHLL instructions that include a context synchronization specifier allows a programmer to specify a condition (or signal) to cause a context swap to occur. For example, two threads may access a shared memory sub-system, e.g., one of memory sub-systems 113-115. Each of the memory controllers 113b-115b sends a completion signal when a requested memory access received from one of the programmable micro-engine threads has completed and the requested memory data has been read or written. When the programmable micro-engines 116a-116f receives the completion signal, the programmable micro-engines 116a-116f can determine which thread to execute based on a context synchronization specifier that specifies that condition, i.e., receipt of the completion signal.

One example of an application for the hardware-based multithreaded processor 112 is as a network processor. As a network processor, the hardware-based multithreaded processor 112 interfaces to network devices such as a Media Access Controller (MAC) device (not shown) or a Gigabit Ethernet device (not shown). In general, as a network processor, the hardware-based multithreaded processor 112 can interface to any type of communication device or interface that receives or sends large amounts of data. Processing system 100 functioning in a networking application can receive network packets and process those packets in a parallel manner.

XHLL Instructions

In an embodiment, XHLL instructions include a set of memory specifiers that allow a programmer to specify an action related to a specific memory sub-system 113-115. As an example, and as shown below in Examples 1-4, XHLL instructions include “declspec( )” instructions that allow a programmer to declare a variable (or pointer) along with a memory specifier that specifies a memory sub-system where the data value for that variable will be stored. When the declspec( ) instruction is compiled by process 200 and executed by one of the micro-engines 116a-116f, a variable corresponding to the variable in the declspec( ) instruction will be stored in a location within the specified memory sub-system 113-115. In each of Examples 1-4 (below) one or more memory specifiers are included in the instructions (located within the “( )” portion of each instruction) that specify the memory sub-system (i.e., a memory region) for storing the corresponding data and/or a pointer:

### EXAMPLE 1

declspec(SCRATCH) var1

declspec (SRAM) var2

declspec (SDRAM) var3

Example 1 includes: a declaration of a first variable “var1” that will be stored in SCRATCH RAM 113a; a declaration of a second variable “var2” that will be stored in SRAM 114a; and a declaration of a third variable “var3” that will be stored in SDRAM 115a.

### EXAMPLE 2

declspec(SRAM) struct msg_header header;

Example 2 includes a declaration of a data structure with a variable of type “msg_header” which will be stored in SRAM 114a. Example 2 is an instruction that declares a variable named “header” of type “msg_header” stored in SRAM. also includes a pointer, “header”, that will also be stored in SRAM and may be used to point to the data structure “msg_header”.

### EXAMPLE 3

declspec(SDRAM) buffer * buf_ptr;

Example 3 includes a declaration of a data buffer, “buffer”, that will be stored in SDRAM 115a and includes a pointer to the data buffer called “buf_ptr”. Please note that in Example 3, since “buf_ptr” is not specifically assigned to a memory sub-system, “buf_ptr” will be assigned by default to a general purpose register of the executing micro-engine.

### EXAMPLE 4

buffer declspec(SDRAM)*declspec(SCRATCH) buf_ptr_{—}1;

Example 4 includes a declaration of a pointer “buf_ptr_1” that will be stored in a SCRATCH RAM 113a location. “Buf_ptr_{—}1” will point to a data buffer “buffer” that will be stored in SDRAM 115a.

The declspec( ) instructions have the memory specifier included within the parentheses “( )” and it applies to the variable declaration preceding the memory specifier. That is, the first memory specifier in Example 4 indicates that the data buffer is to be stored in SDRAM 115a, while the second memory specifier indicates the pointer is to be stored in SCRATCH RAM 113a.

Shared Data

XHLL instructions include a shared specifier used to declare and/or use a shared variable stored in one of the memory sub-systems 113b-115b or a register. In this way, a first thread executing on a micro-engine may declare a shared variable that is stored in one of the memory sub-systems 113-115 or stored in a micro-engine register that is accessible by other threads executing on that micro-engine. This reduces the need to re-load variables when a thread is swapped in for execution by a micro-engine. As shown in Examples 5-7 (below), XHLL instructions include a shared specifier used to declare and/or use a shared variable.

### EXAMPLE 5

declspec(shared) var5

Example 5 declares a shared variable “var5”. The shared data specifier may also be combined with a memory region specifier in a single declspec( ) instruction, as shown below in Example 6.

### EXAMPLE 6

declspec(shared SRAM) int x;

Example 7 (below) includes a declspec( ) instruction that does not specify a memory region, therefore, a register on a micro-engine (if available) is used to store the declared variable.

### EXAMPLE 7

declspec(shared) int x; uses a register, if available

Variables are usable by all threads when a shared specifier is used to declare them, alternatively, each varaiable required by a thread will be replicated.

Global Data

In some cases it is useful for a programmer to declare data that is “global”, i.e., shared between all of the micro-engines 116a-116f in processor 112. In an embodiment, XHLL instructions include “export” and/or “import” specifiers that are used to declare a global export variable in a first instruction that may be imported by a second instruction. During the performance of compiler process 200, any “export” and “import” specifiers included in source code file instructions are linked during back end sub-process (12), i.e., the imported symbols are determined from another exported symbol. Examples 8-9 (below) show the use of “export” and “import” specifiers.

### EXAMPLE 8

declspec(export) var7

### Example 9

declspec(import) var7

Example 8 shows an exported/global variable “var7” that is imported by a second instruction in Example 9.

Exported and imported variables may also be bound to a memory region, as shown in Example 10 (below).

### EXAMPLE 10

declspec(SDRAM import) long long buffer[BUFFER_SIZE];

During the performance of process 200, XHLL variables that are declared without a memory region specifier are allocated as follows: Variables up to 32 bytes in size are allocated to a register, if available. If there are not enough registers to accommodate a variable declaration, the variable is stored in a location in SRAM 114a. Variables larger than 32 bytes will be stored in an SRAM location. Pointers declared without a memory specifier will point to an SRAM location.

Transfer Register Specifiers

As described previously, each of the micro-engines 116a-116f includes four sets of XFRs for reading and writing data to/from SRAM 114b and SDRAM 113b. The XHLL instructions include transfer register specifiers used to specify one of the set of XFRs associated with a memory sub-system 113b-115b. In this case, transfer register specifiers include: “sram_read_reg” (to specify a read of an XFR associated with SRAM), sram_write_reg” (to specify a write to an XFR associated with SRAM), “dram_read_reg” (to specify a read from an XFR associated with SDRAM), and “dram_write_reg” (to specify a write to a XFR associated with SDRAM). The use of transfer register specifiers allows a programmer to efficiently program system 100 that include asynchronous memories. By way of example, a first instruction in a thread specifies a variable to be read or written through a specific transfer register, which when executed by a micro-engine will cause a memory access to a specific memory sub-system. The thread may include additional instructions, which perform other operations, followed by execution of another instruction that waits for the data declared to the specific transfer register to be completed (or alternatively, checks for a completion signal). Example 11 (below) shows an example of an XHLL instruction that includes a transfer register specifier.

### EXAMPLE 11

declspec(sram_read_reg) buffer[4];

Example 11 includes a first instruction that declares a four (4) word “buffer” in SRAM read XFR 151.

Context Synchronization Specifiers

The XHLL instructions include a set of context synchronization specifiers (see Table 1) that are used by a micro-engine to determine the appropriate scheduling of individual threads, e.g., when a thread is waiting for the completion of a memory access or a signal from another hardware.

TABLE 1

| SPECIFIER | DESCRIPTION |
|---|---|
| sync_none | No synchronization specified. |
| no_signal | No signal requested - same as |
| | sync_none |
| Sig_done | Signal when operation is |
| | complete |
| Ctx_swap | Swap out until operation is |
| | complete |
| voluntary_swap | Swap to another task, but do not |
| | wait for completion to swap in |

Queueing Priority Specifiers

In an embodiment, XHLL instructions include a set of queueing priority specifiers (see Table 2) that are used to specify the handling of a memory access instruction sent to a memory sub-system.

As described previously, each of the memory controllers 113b-115b may include queuing logic that stores memory access commands received from the micro-engines 116a-116f and/or core processor 120. The queueing logic also includes selection logic to select among two or memory access instructions stored for execution by that memory controller. This selection may be based, in part, upon a queueing priority specifier included as part of an XHLL instruction.

TABLE 2

| SPECIFIER | DESCRIPTION |
|---|---|
| queue_default | Use a default queue. |
| optimize_mem | Choose a queue to “optimize” |
| | memory throughput, i.e., operations |
| | may be performed out of order. |
| Any_queue | Place in any queue. |
| Ordered | Place in an ordered queue (for |
| | SRAM etc). All operations in this |
| | queue are processed in order. |
| order_queue | Place in an ordered queue. |
| Priority | Place in a priority queue. |
| | I.e., these operations take priority |
| | over other queues. |

A queueing priority specifier included as part of an XHLL instruction may specify “ordered” or “out of order” selection, for example, of received memory access instructions by a memory sub-system.

### EXAMPLE 12

declspec(sram_read_reg) buffer[4];

declspec(sram) int *pointer;

sram_read(&buffer, pointer, 4, ordered, sig_done);

Example 12 depicts the reading of four (4) words from SRAM. The four (4) words will be stored in a SRAM read transfer register declared as “buffer” from an address indicated by “pointer”. Example 12 also includes a “sram_read( )” instruction that specifies that the scheduling of the read access from SRAM should be handled by SRAM controller 114b in an “ordered” manner (i.e., not in an “out or order” manner). The sram_read( ) instruction of example 12 also includes a “sig_done” specifier that allows a programmer to specify, in a single instruction, the priority handling of a memory access instruction and the context swapping conditions, i.e., whether a thread should be swapped out of execution, or, will be signaled (i.e., “sig_done”) when the operation is completed.

Compiler Instructions

Compiler instruction “ctx( )” causes compiler process 200 to determine a context number for a context scheduled for execution, for example, context number 0-3. Based on this determination compiler process 200 may select different sequences of instructions for execution by a micro-engine. Example 14 (below) includes a compiler instruction ctx( ) followed by a set of tasks, task_{—}0-task_{—}3. Each task represents a separate set of instructions that are to be performed, depending on the current context scheduled for execution.

### EXAMPLE 14

switch(ctx( ))

{

case 0: perform_task_{—}0; break;

case 1: perform_task_{—}1; break;

case 2: perform task_{—}2; break;

case 3: perform taks_{—}3; break;

}

Example 14 illustrates how compiler process 200, and compiler instruction ctx( ), are used to specify the execution of multiple tasks on a multi-threaded micro-engine.

Compiler Process 200

Referring back to FIG. 2, during the performance of compiler process 200, front end sub-process (208) assembles (208a) each source code file 206a-206c into an intermediate object file (assembly language file) 210a-210c, respectively. One or more of the source code files 206a-206c may include XHLL instructions that include specifiers that are used to control specific hardware in processing system 100 and specifiers that are used to synchronize context swaps. After intermediate object files 210a-210c are assembled, back-end sub-process (212) converts those files into a machine executable program file 214 that is executable by a micro-engine 116a-116f. Back end sub-process 212, may optionally include: context scheduling (212a) based on the on XHLL instructions that access a memory sub-system, allocating registers (212b) for shared and global variables declared by an XHLL instruction, graphing (212c) function calls and returns to determine the placement of those calls and returns in the executable program 214, and, pointer address calculations (212d) based on the granularity of a memory sub-system specified by an XHLL instruction.

Compilation process 200 includes determining from a set of XHLL instructions when a variable will be read or written to one of the memory sub-systems during execution of a program 14. In this case, if an instruction specifies a memory sub-system access, compilation process 200 schedules a context swap while the memory access instruction completes. The context swap may be scheduled later in a program thread if other instructions (and related computations) that follow the memory access instruction do not depend on the memory reference value. In more detail, compilation process 200 may allow multiple writes and reads to one or more of the memory sub-systems to be executed before a context is swapped where it can be determined that no data conflicts will occur in subsequent instructions.

In an embodiment of compilation process 200, the performance of process 200 is not completed until all of the separate source code files 206a-206c have been assembled into intermediate object files 210a-210c. Therefore, compilation process 200 may link all intermediate modules 10a-10c together during back end sub-process (212). During the performance of back end sub-process (212), process 200 may also create (212c) a graph all function calls and create (212c) a graph of all variable declarations included in intermediate files 210a-210c. The graph (i.e., a table) of function calls is used by compilation process 200 to determine where in the executable program function calls and returns should be executed, for example. The graph of variable declarations, especially shared and global declarations, is used by process 200 to determine which variables to store in registers and/or one of the other memory sub-systems, for example. This way of using the call graph and variable declaration graph is especially useful to reduce the total size of the executable program, since the control stores 130a-130f in each micro-engine 116a-116f is of a limited size. Therefore, the graph of function calls may be used to determine the placement of function calls and returns in the executable program, reducing the stacking of return addresses and reducing the amount of saving and restoring of registers between function calls.

As described previously, SCRATCH RAM 113a and SRAM 114a are addressable by longwords (32 bits) and SDRAM 115a is addressable by quadwords (64 bits). Pointers are used to address data stored in a memory sub-system, however the pointer address calculation will vary since the address granularity of each memory sub-system is different. In an embodiment, process 200 includes pointer calculations (12d), i.e., calculating the machine address for each pointer declared based on the address granularity of each memory sub-system. For example, when incrementing a pointer for a “*long long” pointer to an SRAM 114a location, the pointer value is incremented by 2, whereas if incrementing the same pointer “*long long” to an SDRAM 114a location, the pointer value is incremented by 1. A corresponding inverse adjustment is performed for pointer difference operations. Other instructions may also be used to adjust for address granularity of the various memory sub-systems, for example shifting instructions may be used.

FIG. 3 shows a computer 300 on which compilation process 200 may be implemented. Computer 300 includes a processor 310, a memory 312, and a storage medium 314 (see view 336). Storage medium 314 stores data 318 and machine-executable instructions 320 that are executed by processor 310 out of memory 312 to perform compilation process 200.

Although a personal computer is shown in FIG. 3, process 200 is not limited to use with the hardware and software of FIG. 3. It may find applicability in any computing or processing environment. Process 200 may be implemented in hardware, software, or a combination of the two. Process 200 may be implemented in computer programs executing on programmable computers or other machines that each include a processor, a storage medium readable by the processor (including volatile and non-volatile memory and/or storage components), at least one input device, and one or more output devices. Program code may be applied to data entered using an input device (e.g., a mouse or keyboard) to perform process 200 and to generate output information.

Each such program may be implemented in a high level procedural or object-oriented programming language to communicate with a computer system. However, the programs can be implemented in assembly or machine language. The language may be a compiled or an interpreted language.

Each computer program may be stored on a storage medium/article (e.g., CD-ROM, hard disk, or magnetic diskette) that is readable by a general or special purpose programmable computer for configuring and operating the computer when the storage medium or device is read by the computer to perform process 200. Process 200 may also be implemented as a machine-readable storage medium, configured with a computer program, where, upon execution, instructions in the computer program cause a machine to operate in accordance with process 200. The invention is not limited to the specific embodiments described above. For example, more or fewer of memory sub-systems 113-115 may be included on the board (or integrated circuit) of processor 112.

Other embodiments not described herein are also within the scope of the following claims.

What is claimed is:

1. A computer instruction comprises:
a declaration instruction that results in a variable name being associated with a memory location in one of a plurality of memories, the declaration instruction having a first field to specify the variable name, a second field to specify a one of the plurality of memory systems to associate with the variable name.

2. The instruction of claim 1, further comprising:
a third field to declare a pointer corresponding to the location in memory associated with the variable name.

3. The instruction of claim 2, further comprising:
a fourth field to specify a one of the plurality of memories for storing a value corresponding to the pointer.

4. The instruction of claim 1, wherein the instruction results in the variable being replicated for each thread executing in the micro-engine.

5. The instruction of claim 1, further comprising:
a shared specifier that results in the variable declared to be shared by each executable threads on a single micro-engine.

6. The instruction of claim 1, further comprising:
a global specifier that results in the variable declared to be sharable by executable threads on two or more micro-engines.

7. The instruction of claim 1, further comprising:
a transfer register specifier that results in the variable name being associated with a transfer register corresponding to the one of the plurality of memories.

8. The instruction of claim 1, further comprising:
a context synchronization specifier that causes a micro-engine when executing the instruction to determine whether to swap the current thread out of execution.

9. The instruction of claim 8, wherein the determination of whether to swap a context out of execution is based upon a signal from a one of the plurality of memories, the signal used to indicate completion of an operation previously intitiated by the instruction.

10. The instruction of claim 1, further comprising:
a queueing priority specifier that causes a hardware block associated with the one of the plurality of memories to select a received memory access based on the queueing priority specifier.

11. A method of compiling an executable program from a plurality of source code files, the method comprising:
converting each of the plurality of source code files into a corresponding assembly level object file;
linking all of the assembly level object files, wherein linking further comprises:
assembling a graph of at least one of all call instructions and all variable declarations included in the object files before assembling the executable program, and
determining that a first instruction included in a one of the plurality of source code files will cause an access to a one of a plurality of memories included in a processing system.

12. The method of claim 11, further comprising:
selecting a sequence of instructions for execution by a micro-engine that will delay the access to the determined one of the plurality of memories.

13. The method of claim 11, wherein determining further comprises:
determining that the first instruction when executed will access a data value stored in the one of the plurality of memories is followed by at least one subsequent instruction that does not require the data value being accessed by the first instruction; and
selecting the subsequent instruction for execution.

14. The method of claim 11, further comprising:
calculating a pointer value referenced in the first instruction based on an address granularity of the one of the plurality of memories specified by the first instruction.

15. The method of claim 11, wherein determining further comprising:
determining the first instruction includes a context inquiry modifier; and
determining a context number corresponding to the first instruction that may be executed by a micro-engine, wherein the context number is used to determine the flow of execution of the executable program.

16. The method of claim 11, wherein the first instruction includes an export specifier associated with a variable, and a second instruction includes an import specifier associated with the variable, the method further comprises:
using a value associated with the exported variable to determine the value of the imported variable.

17. A storage medium having stored thereon instructions that when executed by a network processor results in the following:
a data item to be read from or written to one of a plurality of memories,
wherein a one of the instructions includes a first field to specify the one of the plurality of memory systems, the instruction also having a second field to declare a variable or a pointer corresponding to the data item.

18. The medium of claim 17, wherein the one of the instructions includes a third field to specify a one of the plurality of memories for storing the variable or pointer declared by the second field.

19. The medium of claim 18, wherein the one of the instructions includes a shared specifier that causes the variable declared to be shared by each executable thread on a single micro-engine.

20. The medium of claim 19, wherein the one of the instructions when accessed by the machine results in the shared variable to be stored in the one of the plurality of memories corresponding to the third specifier.

21. The medium of claim 18, wherein the one of the instructions includes a global specifier that causes the variable declared to be sharable by executable threads on two or more micro-engines.

22. The medium of claim 21, wherein the one of the instructions when executed by the machine results in the global variable to be stored in a one of the plurality of memories, the one of the plurality of memories corresponding to the first specifier included in the instruction.

23. The medium of claim 18, wherein the one of the instructions includes a register specifier that causes the variable to be associated with a location in a register corresponding to a one of the plurality of memories.

24. The medium of claim 18, wherein the one of the instructions includes a context synchronization specifier that causes a micro-engine to determine whether to swap the current thread out of execution.

25. The medium of claim 24, wherein the determination of whether to swap a context out of execution is based upon a signal from a one of the plurality of memories, the signal used to indicate completion of an operation intitiated by a previous instruction in the context.

26. The medium of claim 18, wherein the instruction includes a queueing priority specifier that causes a hardware block associated with the one of the plurality of memories to perform a selection of a received memory access based on the queueing priority specifier.

27. A processing system for executing multiple threads, comprising:
a plurality of multi-threaded micro-engines;
a first memory coupled to the plurality of micro-engines to receive data from and transmit data to the plurality of micro-engines; and
a second memory coupled to the plurality of micro-engines to receive data from and transmit data of the plurality of micro-engines,
wherein one of the plurality of micro-engines executes an instruction that causes an access to one of the first or second memories and also includes sending a queueing priority specifier corresponding to the handling of the memory access.

28. The processing system of claim 27, wherein the access to memory causes a transfer register on the one of the plurality of micro-engines to be associated with the memory access to the one of the memories.
